(19) United States
(12) Patent Application Publication
(10) Pub. No.: US 2015/0199679 A1
(43) Pub. Date: Jul. 16, 2015

(54) MULTIPLE TOKEN PROVISIONING

(71) Applicants: Karthikeyan Palanisamy, Dublin, CA (US); Glenn Powell, Fremont, CA (US); Prasanna Laxminarayanan, San Ramon, CA (US)

(72) Inventors: Karthikeyan Palanisamy, Dublin, CA (US); Glenn Powell, Fremont, CA (US); Prasanna Laxminarayanan, San Ramon, CA (US)

(21) Appl. No.: 14/595,843

(22) Filed: Jan. 13, 2015

Related U.S. Application Data
(60) Provisional application No. 61/926,837, filed on Jan. 13, 2014.

(51) Int. Cl. G06Q 20/36

(52) U.S. Cl. CPC G06Q 20/3674

(57) ABSTRACT

An issuer computer may store a primary account number, and may generate a series of first payment tokens for a plurality of payment devices used by a consumer. The issuer computer may then provide the first payment tokens to a payment processing server computer. The payment processing server computer may then generate a plurality of second payment tokens corresponding to the first payment tokens. The second payment tokens may then be provisioned onto the consumer's payment devices.

### CROSS-REFERENCES TO RELATED APPLICATIONS

This application is a non-provisional of and claims the benefit of the filing date of U.S. provisional application No. 61/926,837, filed on Jan. 13, 2014, which is herein incorporated by reference in its entirety for all purposes.

### BACKGROUND

To reduce the risk of payment card fraud, the payments industry has proposed the use of payment tokens. A payment token is a substitute for a PAN or primary account number. If the payment token is stolen by an unauthorized person, then the underlying PAN is still safe and does not have to be replaced.

Since a consumer may often have multiple payment devices, those payment devices may be provisioned with the same payment token. For example, a consumer may have a payment card and a mobile phone. Both of these devices may be used as payment devices, and both may store the same payment token.

While conventional systems are useful, they could be improved. For example, if one of the payment devices is compromised (e.g., a mobile phone), then the other payment devices (e.g., a credit card) that store the same payment token will need to be provisioned with the new token. This can be inconvenient for the consumer and the issuer of the tokens.

Further, in some cases, payment tokens are not typically issued by an issuer of a PAN, but are issued by a central token vault. The issuer of the PAN may be contacted by the consumer and may be informed that the payment token on one of the consumer's payment devices is compromised (e.g., the mobile phone). To prevent further use of the compromised payment token, the issuer must communicate with the central token vault to invalidate the payment token. This can be time consuming and cumbersome. The communication delay can increase the risk that the stolen payment token will be used in an unauthorized manner, thereby increasing the risk of loss.

Embodiments of the invention address these and other problems individually and collectively.

### SUMMARY

Embodiments of the invention are directed to methods and systems for provisioning tokenized payment credentials.

One embodiment of the invention is directed to a method. The method comprises receiving, by a payment processor server computer, a provisioning request associated with a communication device. The provisioning request includes a primary account identifier of an account associated with an issuer. The method also includes sending, by the payment processor server computer, the provisioning request to an issuer server computer, and receiving, by the payment processor server computer, a provisioning response from the issuer server computer. The provisioning response includes a first payment token that is associated with the primary account identifier, that was generated by the issuer server computer, and that is one of a plurality of first payment tokens associated with the primary account identifier. The method further includes generating, by the payment processor server computer, a second payment token that is associated with the first payment token, storing the first payment token and the second payment token in a payment token database, providing the second payment token to the communication device, and notifying the issuer server computer that the second payment token is associated with the first payment token.

Another embodiment of the invention is directed to a server computer comprising a processor, a reader coupled to the processor, and a non-transitory computer readable medium coupled to the processor. The non-transitory computer readable medium comprises code executable by the processor. The code is executable by the processor for implementing a method comprising receiving, by a payment processor server computer, a provisioning request associated with a communication device. The provisioning request includes a primary account identifier of an account associated with an issuer. The method also includes sending, by the payment processor server computer, the provisioning request to an issuer server computer, and receiving, by the payment processor server computer, a provisioning response from the issuer server computer. The provisioning response includes a first payment token that is associated with the primary account identifier, that was generated by the issuer server computer, and that is one of a plurality of first payment tokens associated with the primary account identifier. The method further includes generating, by the payment processor server computer, a second payment token that is associated with the first payment token, storing the first payment token and the second payment token in a payment token database, providing the second payment token to the communication device, and notifying the issuer server computer that the second payment token is associated with the first payment token.

Another embodiment of the invention is directed to a method comprising receiving, by a payment processor server computer, an authorization request message comprising a second payment token for a transaction from a merchant server computer. The method further comprises identifying, by the payment processor server computer, a first payment token that is associated with the second payment token in a payment token database. The second payment token was previously generated by the payment processor server computer and the first payment token was previously generated by an issuer server computer. The method also includes reformatting, by the payment processor server computer, the authorization request message to include the first payment token instead of the second payment token, and transmitting the authorization request message to the issuer server computer. The issuer server computer authorizes the transaction based on a primary account identifier associated with the first payment token at the issuer server computer. The method further comprises receiving, by the payment processor server computer, an authorization response message comprising the first payment token from the issuer server computer, reformatting the authorization response message to include the second payment token instead of the first payment token, and transmitting the authorization response message to the merchant server computer.

Another embodiment of the invention is directed to a server computer comprising a non-transitory computer readable medium coupled to the processer, the non-transitory computer readable medium comprises code executable by the processor for implementing a method. The method comprises receiving, by a payment processor server computer, an authorization request message comprising a second payment token for a transaction from a merchant server computer. The method further comprises identifying, by the payment processor server computer, a first payment token that is associated with the second payment token in a payment token database. The second payment token was previously generated by the payment processor server computer and the first payment token was previously generated by an issuer server computer. The method also includes reformatting, by the payment processor server computer, the authorization request message to include the first payment token instead of the second payment token, and transmitting the authorization request message to the issuer server computer. The issuer server computer authorizes the transaction based on a primary account identifier associated with the first payment token at the issuer server computer. The method further comprises receiving, by the payment processor server computer, an authorization response message comprising the first payment token from the issuer server computer, reformatting the authorization response message to include the second payment token instead of the first payment token, and transmitting the authorization response message to the merchant server computer.

Further details regarding embodiments of the invention can be found in the Detailed Description and the Figures.

### BRIEF DESCRIPTION OF THE DRAWINGS

FIG. 1 shows a block diagram of a provisioning system according to an embodiment of the invention.

FIG. 2 shows a block diagram of an exemplary communication device according to an embodiment of the invention.

FIG. 3 shows an illustration of an exemplary payment device according to an embodiment of the invention.

FIG. 4 shows a block diagram of a payment processor server computer according to an embodiment of the invention.

FIG. 5 shows a block diagram of an issuer server computer according to an embodiment of the invention.

FIG. 6 shows a diagram illustrating payment token relationships according to embodiments of the invention.

FIG. 7 shows a flow diagram illustrating a method for payment token provisioning according to embodiments of the invention.

FIG. 8 shows another flow diagram illustrating a method for STIP (stand in processing) payment token provisioning according to embodiments of the invention.

FIG. 9 shows a payment system according to an embodiment of the invention.

FIG. 10 shows a flow diagram illustrating a method for de-tokenizing during a payment transaction according to embodiments of the invention.

FIG. 11 shows a block diagram of a computer apparatus.

### DETAILED DESCRIPTION

In embodiments of the invention, an issuer computer may store a PAN, and may generate a series of first payment tokens for a plurality of payment devices (e.g., a payment card, a mobile phone, a key fob, etc.) used by a consumer. The issuer computer may then provide the first payment tokens to a payment processing server computer. The payment processing server computer may then generate a plurality of second payment tokens corresponding to the first payment tokens. The second payment tokens may then be provisioned onto the consumer's payment devices.

In embodiments of the invention, different payment devices are provisioned with different payment tokens. If one payment token on one payment device is obtained by an unauthorized person, then the other payment tokens on the other payment devices advantageously do not have to be replaced. Further, because the issuer computer generates the first plurality of payment tokens, the first plurality of payment tokens can serve as a tokenization layer that is under the control of the issuer. If the consumer contacts the issuer and informs the issuer that a second payment token on a particular payment device has been compromised, then the issuer may simply remove or invalidate the corresponding first payment token. In this way, the issuer does not need to contact the central payment processor server computer that generated the second tokens to prevent further use of the compromised second payment token.

Prior to discussing specific embodiments of the invention, some terms may be described in detail.

“Payment credentials” may include any suitable information associated with an account (e.g. a payment account and/or payment device associated with the account). Such information may be directly related to the account or may be derived from information related to the account. Examples of account information may include a PAN (primary account number or “account number”), user name, expiration date, CVV (card verification value), dCVV (dynamic card verification value), CVV2 (card verification value 2), CVC3 card verification values, etc. CVV2 is generally understood to be a static verification value associated with a payment device. CVV2 values are generally visible to a user (e.g., a consumer), whereas CVV and dCVV values are typically embedded in memory or authorization request messages and are not readily known to the user (although they are known to the issuer and payment processors). Payment credentials may include at least one payment token. Payment credentials may also include at least one digital wallet identifier.

A “payment token” may include an identifier for a payment account that is a substitute for an account identifier, such as a primary account number (PAN). For example, a token may include a series of alphanumeric characters that may be used as a substitute for an original account identifier. For example, a token “4900 0000 0000 0001” may be used in place of a PAN “4147 0900 0000 1234.” In some embodiments, a token may be “format preserving” and may have a numeric format that conforms to the account identifiers used in existing payment processing networks (e.g., ISO 8583 financial transaction message format). In some embodiments, a token may be used in place of a PAN to initiate, authorize, settle or resolve a payment transaction or represent the original credential in other systems where the original credential would typically be provided. In some embodiments, a token value may be generated such that the recovery of the original PAN or other account identifier from the token value may not be computationally derived. Further, in some embodiments, the token format may be configured to allow the entity receiving the token to identify it as a token and recognize the entity that issued the token.

A “payment device” or “portable consumer device” may include any suitable device that may be used to conduct a financial transaction, such as to provide payment information to a merchant. A portable consumer device may be in any suitable form. For example, suitable portable consumer devices can be hand-held and compact so that they can fit into a consumer's wallet and/or pocket (e.g., pocket-sized). They may include smart cards, magnetic stripe cards, keychain devices (such as the Speedpass™ commercially available from Exxon-Mobil Corp.), etc. Other examples of portable consumer devices include cellular phones, personal digital assistants (PDAs), pagers, payment cards, security cards, access cards, smart media, transponders, and the like. If the portable consumer device is in the form of a debit, credit, or smartcard, the portable consumer device may also optionally have features such as magnetic stripes. Such devices can operate in either a contact or contactless mode.

A “communication device” may comprise any electronic device that may be transported and operated by a user, which may also provide remote communication capabilities to a network. Examples of remote communication capabilities include using a mobile phone (wireless) network, wireless data network (e.g. 3G, 4G or similar networks), Wi-Fi, Wi-Max, or any other communication medium that may provide access to a network such as the Internet or a private network. Examples of communication devices include mobile phones (e.g. cellular phones), PDAs, tablet computers, net books, laptop computers, personal music players, hand-held specialized readers, etc. A communication device may simultaneously be a payment device in some embodiments of the invention.

“Short range communication” or “short range wireless communication” may comprise any method of providing short-range contact or contactless communications capability, such as RFID, Bluetooth™, infra-red, or other data transfer capability that can be used to exchange data between a communication device (or a portable consumer device) and an access device. In some embodiments, short range communications may be in conformance with a standardized protocol or data transfer mechanism (e.g., ISO 14443/NFC). Short range communication typically comprises communications at a range of less than 2 meters. In some embodiments, it may be preferable to limit the range of short range communications (e.g., to a range of less than 1 meter, less than 10 centimeters, or less than 2.54 centimeters) for security, technical, and/or practical considerations.

An “application” may be computer code or other data stored on a computer readable medium (e.g. memory element or secure element) that may be executable by a processor to complete a task.

A “digital wallet” can include an electronic device that allows an individual to conduct electronic commerce transactions. A digital wallet may store user profile information, payment information, bank account information, one or more digital wallet identifiers and/or the like and can be used in a variety of transactions, such as but not limited to eCommerce, social networks, money transfer/personal payments, mobile commerce, proximity payments, gaming, and/or the like for retail purchases, digital goods purchases, utility payments, purchasing games or gaming credits from gaming websites, transferring funds between users, and/or the like.

A “digital wallet provider” may include an entity, such as an issuing bank or third party service provider, that issues a digital wallet to a user that enables the user to conduct financial transactions. A digital wallet provider may provide standalone user-facing software applications that store account numbers, or representations of the account numbers (e.g., payment tokens), on behalf of a cardholder (or other user) to facilitate payments at more than one unrelated merchant, perform person-to-person payments, or load financial value into the digital wallet. A digital wallet provider may enable a user to access its account via a personal computer, communication device or POS device. Additionally, a digital wallet provider may also provide one or more of the following functions: storing multiple payment cards and other payment products on behalf of a user, storing other information including billing address, shipping addresses, and transaction history, initiating a transaction by one or more methods, such as providing a user name and password, NFC or a physical token, and may facilitate pass-through or two-step transactions. In some implementations, a user's issuing bank may be the digital wallet provider. Alternatively, the digital wallet provider may be a third party entity.

A “provisioning request message” may be an electronic message for requesting provisioning of payment credentials to a communication device, a digital wallet, or any other suitable location. Provisioning request messages may include payment credentials, communication device identification information (e.g. a secure element identifier), a digital wallet identifier and any other suitable information.

A “provisioning response message” may be an electronic message sent in response to a provisioning request message. Provisioning response messages may indicate whether provisioning has been approved or denied. Provisioning response messages may also include payment credentials, provisioning scripts, and any other suitable information for provisioning payment credentials.

A “provisioning script” may include may include any source code, machine code, executable file, or other instructions operable to provision a device or assist in the provisioning of a device. A provisioning script may be written in any suitable programming language, such as C, C++, Java, Python, or assembly. In some cases, the provisioning script may include specific calls or commands to hardware elements. For example, if an EMV card or communication device is being provisioned, a provisioning script may operate according to “EMV Card Personalization Specification version 1.0,” which defines commands that may be used to provision an EMV smart card. In some cases, a provisioning script may comprise personalization data in addition to instructions operable to provision the personalization data.

As used herein, an “issuer” may typically refer to a business entity (e.g., a bank) that maintains financial accounts for a consumer and issues payment credentials stored on communication device, such as a cellular telephone, smart card, tablet, or laptop, to the consumer.

A “merchant” is typically an entity that engages in transactions and can sell goods or services.

An “acquirer” is typically a business entity (e.g., a commercial bank) that has a business relationship with a particular merchant or other entity. Some entities can perform both issuer and acquirer functions. Some embodiments may encompass such single entity issuer-acquirers. Each of the entities (e.g., merchant, acquirer, payment processor, and issuer) may comprise one or more computer apparatuses to enable communications or to perform one or more of the functions described herein.

A “payment processing network” may include data processing subsystems, networks, and operations used to support and deliver certificate authority services, authorization services, exception file services, and clearing and settlement services. An exemplary payment processing network may include VisaNet™. Payment processing networks such as VisaNet™ are able to process credit card transactions, debit card transactions, digital wallet transactions, and other types of commercial transactions. VisaNet™, in particular, includes a VIP system (Visa Integrated Payments system) which processes authorization requests and a Base II system which performs clearing and settlement services. In some embodiments, payment processors may conduct transactions in substantially real-time.

An “authorization request message” may be an electronic message that is sent to a payment processing network and/or an issuer of a payment card to request authorization for a transaction. An authorization request message according to some embodiments may comply with ISO 8583, which is a standard for systems that exchange electronic transaction information associated with a payment made by a consumer using a payment device (e.g., a communication device) or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), an expiration date, etc. An authorization request message may also comprise “transaction information,” such as any information associated with a current transaction, such as the transaction amount, merchant identifier, merchant location, etc., as well as any other information that may be utilized in determining whether to identify and/or authorize a transaction. The authorization request message may also include other information such as information that identifies the access device that generated the authorization request message, information about the location of the access device, etc.

An “authorization response message” may be an electronic message reply to an authorization request message generated by an issuing financial institution or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the payment processing network) to the merchant's access device (e.g. POS equipment) that indicates approval of the transaction. The code may serve as proof of authorization. As noted above, in some embodiments, a payment processing network may generate or forward the authorization response message to the merchant.

A “server computer” may include any suitable computer that can provide communications to other computers and receive communications from other computers. A server computer may include a computer or cluster of computers. For example, the server computer can be a mainframe, a minicomputer cluster, or a group of servers functioning as a unit. In one example, a server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers. Data transfer and other communications between components such as computers may occur via any suitable wired or wireless network, such as the Internet or private networks.

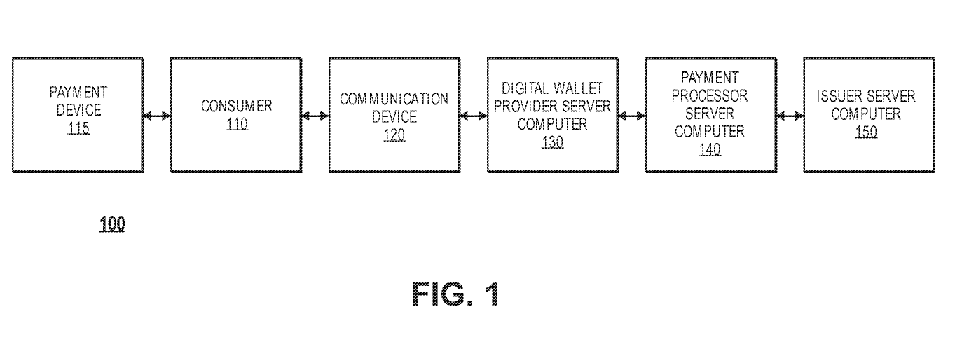

FIG. 1 shows a provisioning system 100 comprising a number of components. The system 100 comprises a consumer 110 in possession of a communication device 120 and a payment device 115. The system 100 further comprises a digital wallet provider server computer 130, a payment processor server computer 140, and an issuer server computer 150, which each may be in communication with one another and/or the communication device 120.

In embodiments of the invention, as explained above, the issuer server computer 150 can generate a plurality of first payment tokens based on a PAN. The payment processing server computer 140 may be part of a payment processing network that can generate a second plurality of payment tokens based on the first plurality of payment tokens. The second payment tokens may be provisioned to the payment device 115 and the communication device 120, and may be used by the consumer 110 to conduct purchase transactions.

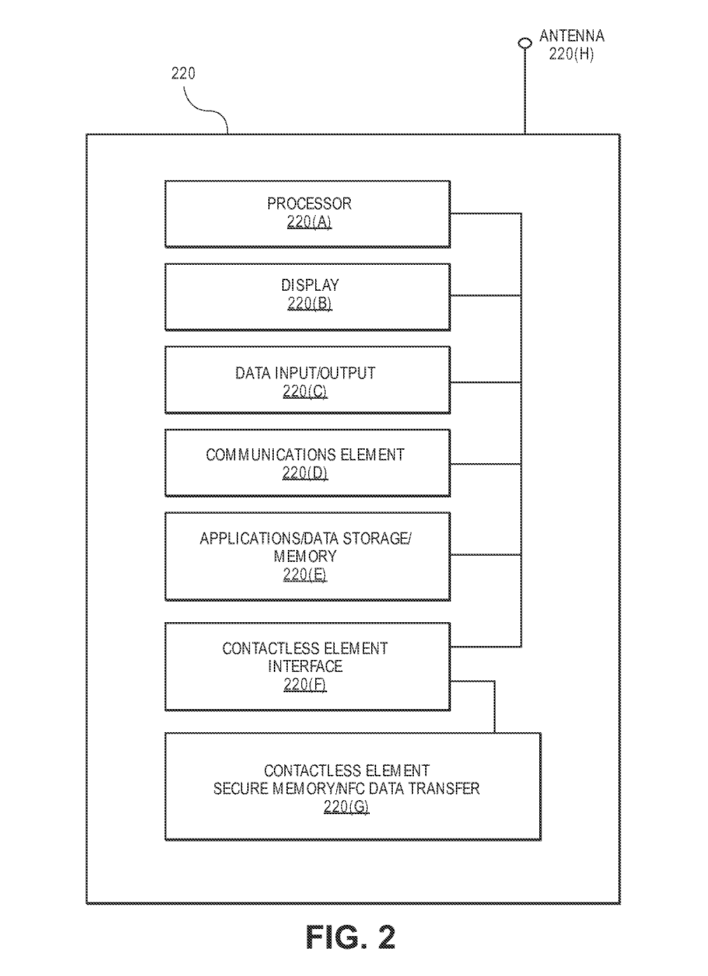

FIG. 2 shows an example of a communication device 220 according to some embodiments of the invention. The communication device 220 is analogous to the communication device 120 in FIG. 1. Communication device 220 may include circuitry that is used to enable certain device functions, such as telephony. The functional elements responsible for enabling those functions may include a processor 220(A) that can execute instructions that implement the functions and operations of the device. Processor 220(A) may access data storage 220(E) (or another suitable memory region or element) to retrieve instructions or data used in executing the instructions, such as provisioning scripts and mobile applications. Data input/output elements 220(C), such as a keyboard or touchscreen, may be used to enable a user to operate the communication device 220 and input data (e.g., user authentication data). Data input/output elements may also be configured to output data (via a speaker, for example). Display 220(B) may also be used to output data to a user. Communications element 220(D) may be used to enable data transfer between communication device 220 and a wired or wireless network (via antenna 220(H), for example) to assist in connectivity to the Internet or other network, and enabling data transfer functions. Communication device 220 may also include contactless element interface 220(F) to enable data transfer between contactless element 220(G) and other elements of the device, where contactless element 220(G) may include a secure memory and a near field communications data transfer element (or another form of short range communications technology). As noted, a cellular phone or similar device is an example of a communication device 220 that may be used in accordance with embodiments of the present invention. However, other forms or types of devices may be used without departing from the underlying concepts of the invention. Further, devices that are provisioned may not require the capability to communicate using a cellular network in order to be suitable for use with embodiments of the present invention.

In some embodiments, a second payment token may be stored in the secure memory in the contactless element 220(G) or in the memory 220(E).

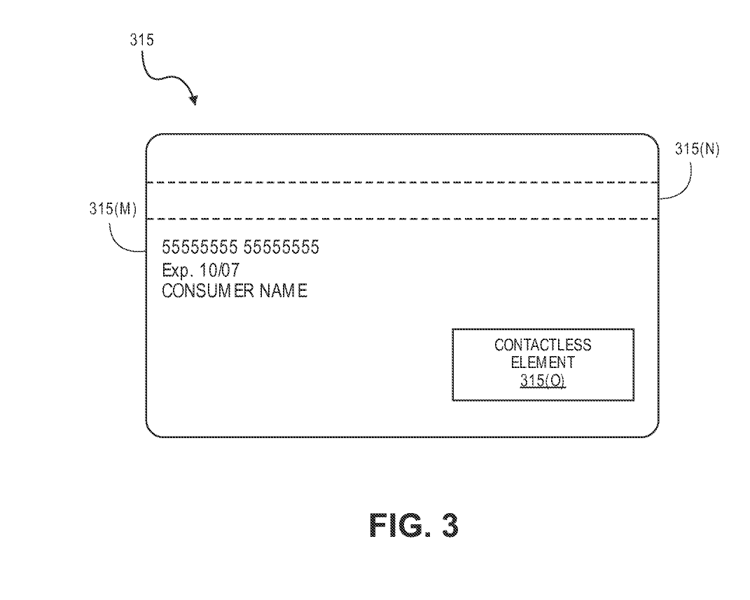

FIG. 3 shows an exemplary payment device 315 in the form of a payment card that can be used in embodiments of the invention. The payment device 315 is analogous to the payment device 115 in FIG. 1. FIG. 3 shows a plastic substrate 315(M). A contactless element 315(O) for interfacing with an access device may be present on or embedded within the plastic substrate 315(M). Consumer information 315(P) such as an account number, expiration date, and consumer name may be printed or embossed on the card. Further, a magnetic stripe 315(N) may also be on the plastic substrate 315(M). The payment device 315 may also comprise a microprocessor and/or memory chips with user data stored in them.

In some embodiments, a second payment token may be stored in the memory chips or magnetic stripe 315(N) in the payment device 315.

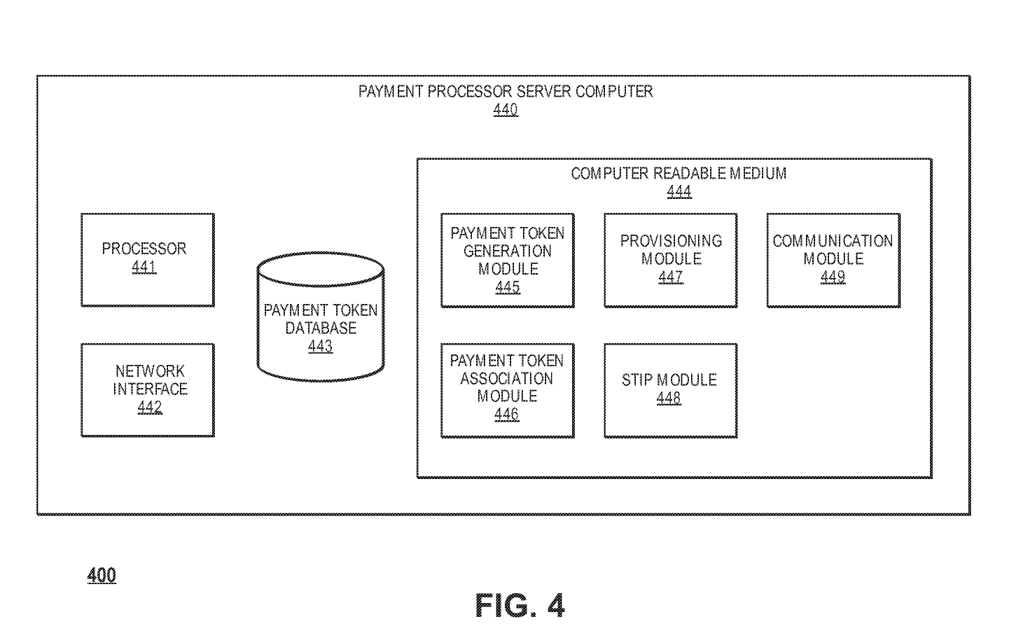

FIG. 4 shows a block diagram 400 showing basic components that may reside in an exemplary payment processor server computer 440. The payment processing server computer 440 may be analogous to the payment processing server computer 140 in FIG. 4. It may form part of a payment processing network in some embodiments of the invention. The payment processor server computer 440 comprises a processor 441, a network interface 442, a payment token database 443, and a computer readable medium 444.

The computer readable medium 444 may comprise a payment token generation module 445, a payment token association module 446, a provisioning module 447, a Stand-In Processing (STIP) module 448, and a communication module 449. It may also comprise code, executable by the processor 441 for implementing a method comprising: receiving a provisioning request associated with a communication device, the provisioning request including a primary account identifier of an account associated with an issuer; sending the provisioning request to an issuer server computer; receiving a provisioning response from the issuer server computer, the provisioning response including a first payment token associated with the primary account identifier and generated by the issuer server computer, the first payment token being one of a plurality of first payment tokens associated with the primary account identifier; generating a second payment token associated with the first payment token; storing the first payment token and the second payment token in a payment token database; providing the second payment token to the communication device; and notifying the issuer server computer that the second payment token is associated with the first payment token.

The payment token generation module 445 may comprise code that causes the processor 441 to generate a second payment token, such as a second payment token that includes 16 digits and that resembles a PAN.

The second payment token may be generated in any suitable manner. For example, the second payment token may be generated using an algorithm that converts a first payment token into the second payment token. In some embodiments, the algorithm may be an encryption algorithm such as DES, triple DES, etc. In another example, the second payment token may be randomly or non-randomly generated, and then may be linked to a corresponding first payment token.

The payment token association module 446 may comprise code that causes the processor 441 to associate a payment token with other payment credentials. For example, the payment token association module 446 may contain logic that causes the processor 441 to link a generated second payment token with a received first payment token, and to store the information in the payment token database 443.

The provisioning module 447 may comprise code that causes the processor 441 to provision payment credentials. For example, the provisioning module 447 may contain logic that causes the processor 441 to generate provisioning scripts, and to provide the provisioning scripts, a payment token, and any other suitable information to a communication device.

The STIP module 448 may comprise code that causes the processor 441 to perform stand-in processing, such as provisioning a payment token to a communication device before receiving authorization from an issuer. For example, if an issuer does not respond to a provisioning request message within a predetermined period of time, the logic in the STIP module 448 may cause the processor 441 to generate a payment token, link the payment token with a consumer's PAN, provision the payment token to a communication device, and then notify the issuer that stand-in processing that has taken place.

The communication module 449 may comprise code that causes the processor 441 to generates messages, reformat messages, and/or otherwise communicate with other entities. For example, the communication module 449 may contain logic that causes the processor 441 to identify a second payment token in a received authorization request message, reformat the authorization request message so that the second payment token is replaced with an associated first payment token, and forward the authorization request message to an issuer.

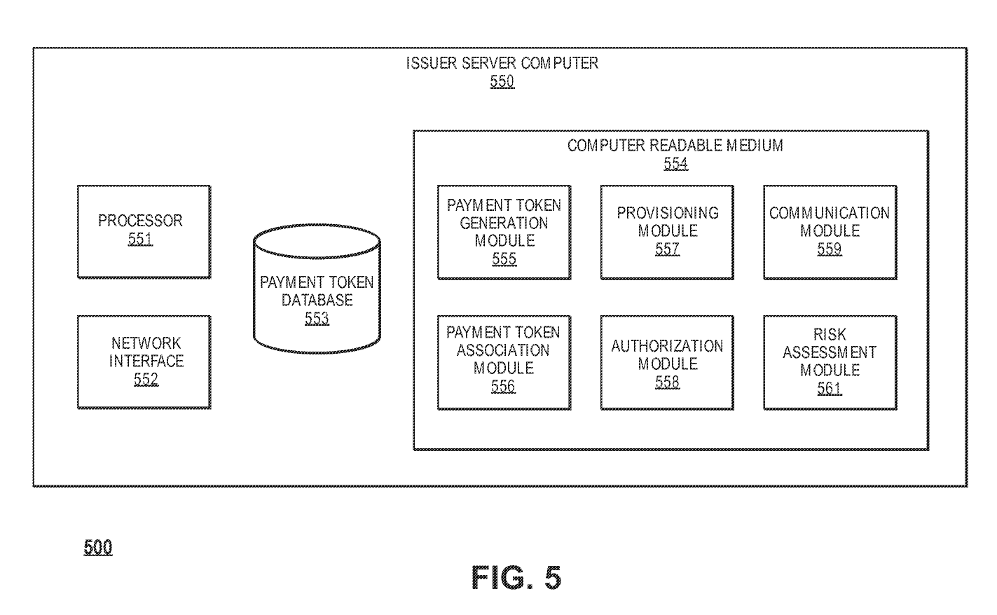

FIG. 5 shows a block diagram 500 showing basic components that may reside in an exemplary issuer server computer 550. The issuer server computer 550 may be analogous to the issuer server computer 150 in FIG. 1. The issuer server computer 550 comprises a processor 551, a network interface 552, a payment token database 553, and a computer readable medium 554.

The computer readable medium 544 may comprise modules similar to the computer readable medium 444 of the payment processor server computer 440. For example, the computer readable medium 544 may comprise a payment token generation module 555, a payment token association module 556, a provisioning module 557, and a communication module 559. The computer readable medium 544 may further include a risk assessment module 561 and an authorization module 558, and any other suitable module. It may also comprise code, executable by the processor 551 for implementing a method comprising receiving a provisioning request that is associated with a communication device and that includes a primary account identifier; generating a first payment token associated with the primary account identifier, wherein the first payment token is one of a plurality of first payment tokens associated with the primary account identifier; storing a record including the first payment token and the primary account identifier in a payment token database; sending a provisioning response message including the second payment token to the payment processor server computer; receiving a notification from the payment processor server computer including a second payment token associated with the first payment token; and updating the record in the payment token database to include the second payment token.

In some embodiments, one or more modules may contain code for performing functions similar to corresponding modules of the payment processor server computer 440. For example, the payment token generation module 555 and the payment token association module 556 may contain logic that causes the processor 551 to generate a first payment token, link the first payment token with a received PAN, and store the information in the payment token database 553. Accordingly, the issuer server computer 550 may be able to provide an additional level of tokenization.

The first payment token may be generated in any suitable manner. For example, the first payment token may be generated using an algorithm that converts a PAN into the first payment token. In some embodiments, the algorithm may be an encryption algorithm such as DES, triple DES, etc. In another example, the first payment token may be randomly or non-randomly generated, and then may be linked to a corresponding PAN.

The risk assessment module 561 may comprise code that causes the processor 551 to assess risk. For example, the risk assessment module 561 may contain logic that causes the processor 551 to determine risk levels associated with provisioning payment credentials and/or issuing a payment token.

The authorization module 558 may comprise code that causes the processor 551 to perform authorization processing. For example, the authorization module 558 may contain logic that causes the processor 551 to authorize or reject authorization request messages for payment transactions. Criteria for determining whether or not a transaction should be accepted or rejected include the risk of fraud, and/or the available funds or credit in the account used to conduct a transaction.

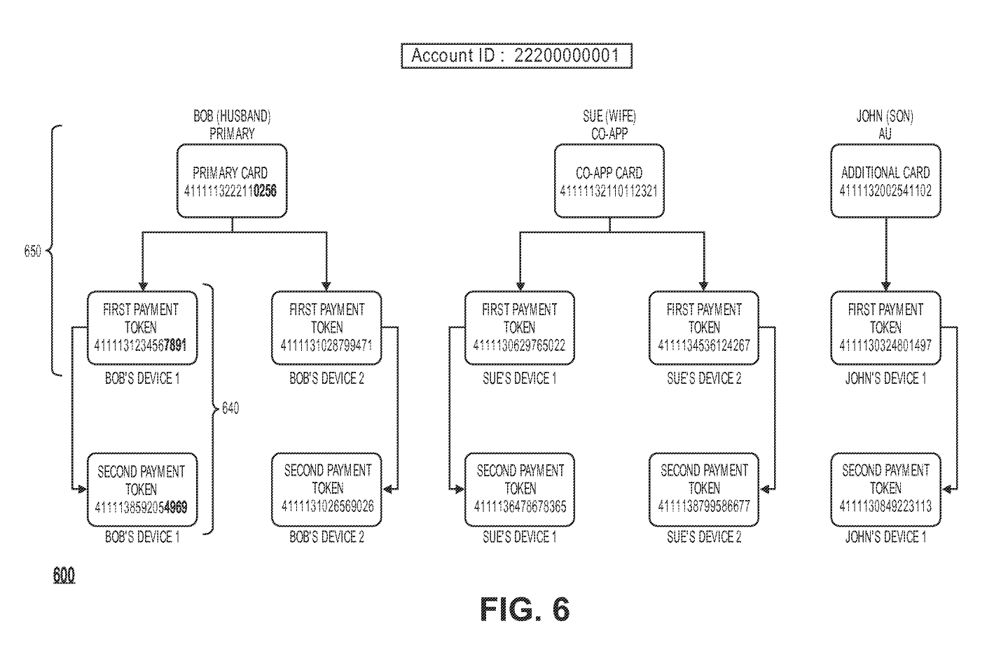

FIG. 6 shows a diagram 600 of an example of layered payment tokenization according to embodiments of the invention. A customer account ID 22200000001 includes three payment accounts at an issuer (e.g. CapitalOne™) As shown in FIG. 6, the payment accounts include Bob's account, Sue's account, and John's account.

Bob's account may comprise a primary card with the PAN 4111113222110256 (also referred to as 0256). A first payment token 4111131234567891 (also referred to as 7891) may be linked with the PAN 0256. The linkage may be established at the issuer (indicated by the bracket 650). Accordingly, if the issuer receives the first payment token 7891 in an authorization request message, the issuer can identify that the first payment token 7891 represents the PAN 0256 and then use the PAN 0256 for the transaction.

Additionally, in some embodiments, the first payment token 7891 may be linked with a second payment token 4111138592054969 (also referred to as 4969). This linkage may be established at a payment processor instead of the issuer (as indicated by the bracket 640). Accordingly, if the payment processor receives the second payment token 4969 in an authorization request message, the payment processor can identify that the second payment token 4969 represents the first payment token 7891, replace the second payment token 4969 with the first payment token 7891, and then forward the authorization request message to the issuer.

Thus, there may be two layers of tokenization, as the second payment token 4969 corresponds to the first payment token 7891 at the payment processor, and the first payment token 7891 corresponds to the PAN 0256 at the issuer. In some embodiments, the second payment token 4969 is provisioned to a communication device, while the first payment token 7891 is kept as a secret between the issuer and the payment processor.

For discussion purposes, the process for linking the PAN 0256, the first payment token 7891, and the second payment token 4969 will be described in detail. However, as seen in FIG. 6, additional first payment tokens can also be associated with the PAN 0256, and each first payment token can have a corresponding second payment token. For example, if the consumer wants to use the same original PAN 0256 to participate in multiple methods of payment across multiple payment channels, an issuer may issue a different channel-specific first payment token for each payment channel. As shown in FIG. 6, the first payment token 7891 is provided for Bob's device 1, and another first payment token 4111131028799471 (that is also linked with the PAN 0256) is provided for Bob's device 2. Channel-specific first payment tokens can also be provided for consumer accounts (e.g. card-on-file accounts at merchants), for usage in e-commerce transactions, and for any other suitable payment channels. Additionally, as shown in FIG. 6, first payment tokens can be issued for other payment accounts and other payment devices, such as Sue's Co-applicant card and John's additional card, that are associated with the same customer account ID 22200000001.

As noted above, in embodiments of the invention, if the second payment token 4969 is stolen from Bob's device 1 or Bob's device 1 is itself stolen, the consumer may contact the issuer of the account ID or PAN. The issuer may then delete or inactivate the first payment token 7891. By doing so, any use of the second payment token 4969 by a fraudster will not be effective. That is, when the issuer receives an authorization request message including the first payment token 7891, the issuer may deny the request, thereby preventing the fraudulent use of the second payment token 4969. The issuer advantageously does not need to contact the payment processor that generated the second payment token 4969, and the first and second payment tokens associated with Bob's device 2 do not have to be replaced.

In some embodiments, the first payment tokens generated by the issuer computer and the second payment tokens generated by the payment processor computer may respectively have characters which indicate their origin. For example, first payment tokens could start with the number “8” while second payment tokens may start with the number “9”.

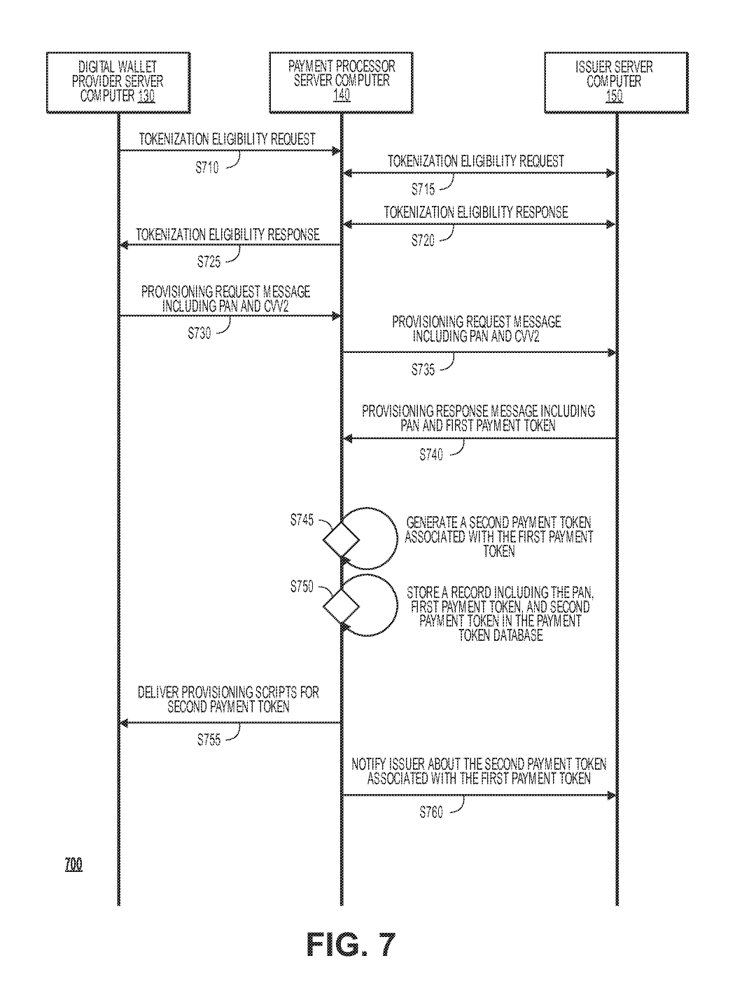

A method 700 according to embodiments of the invention can be described with respect to FIG. 7. Some elements in other Figures are also referred to.

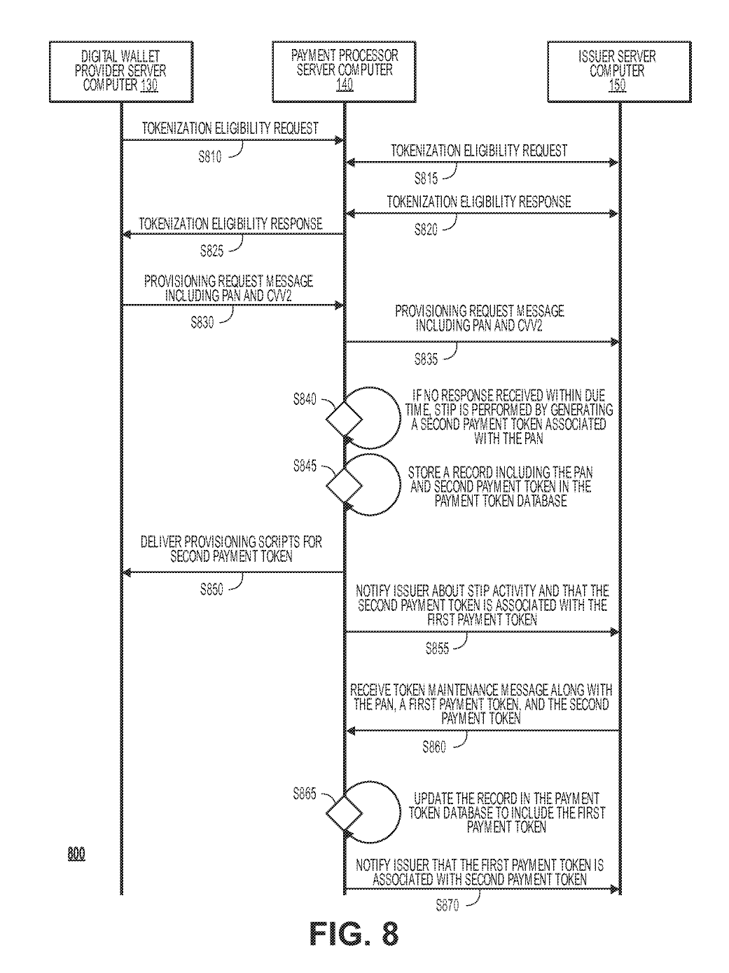

The various messages in FIGS. 7 and 8 may use any suitable form of communication. In some embodiments, a request or response may be in an electronic message format, such as an e-mail, a short messaging service (SMS) message, a multimedia messaging service (MMS) message, a hypertext transfer protocol (HTTP) request message, a transmission control protocol (TCP) packet, a web form submission. The request or response may be directed to any suitable location, such as an e-mail address, a telephone number, an internet protocol (IP) address, or a uniform resource locator (URL). In some embodiments, a request or response may comprise a mix of different message types, such as both email and SMS messages.

A payment credential provisioning process may be initiated. For example, a consumer 110 may indicate a desire to activate mobile payment functionality for the communication device 120 (e.g. Bob's device 1) via a mobile application. The consumer 110 may select Bob's primary card with the PAN 0256 for provisioning to the communication device 120.

In step S710, the payment processor server computer 140 may receive a tokenization eligibility request message including the PAN 0256 and any other suitable information from the digital wallet provider server computer 130, after it communicates with the consumer 110. In some embodiments, instead of involving the digital wallet provider server computer 130, the communication device 120 may communicate directly with the payment processor server computer 140.

In step S715, the payment processor server computer 140 may send the tokenization eligibility request message to the issuer server computer 150 (e.g. using the communication module 449). The issuer server computer 150 may determine whether the PAN 0256 is eligible for being tokenized and provisioned to the communication device 120. For example, the issuer server computer 150 may determine risk levels associated with the PAN 0256 (e.g. using the risk assessment module 561) or perform any other suitable analysis. If the determined risk level is too high, then a subsequently generated tokenization eligibility response message may indicate that a token may not be generated. If the risk level is low, then a subsequently generated tokenization eligibility response message may indicate that a token may be generated.

In step S720, the payment processor server computer 140 may receive a tokenization eligibility response message from the issuer server computer 150. In step S725, the payment processor server computer 140 may send the tokenization eligibility response message to the digital wallet provider server computer 130.

If the tokenization eligibility response indicated that the PAN 0256 is eligible for tokenization and provisioning, the payment processor server computer 140 may receive a provisioning request message from the digital wallet provider server computer 130 in step S730. The provisioning request message may include the PAN 0256, a CVV2, a communication device ID, and any other suitable information (e.g. expiration date, name, address, etc.).

In step S735, the payment processor server computer 140 may send the provisioning request message to the issuer server computer 150. The issuer server computer 150 may determine whether or not to authorize tokenization and provisioning based on the PAN 0256, the communication device 120, and/or any other suitable information. For example, the issuer server computer 150 may authenticate the PAN 0256, authenticate the consumer 110, determine whether the payment account is in good standing, and/or perform any other suitable steps of verification and risk decisioning.

After authenticating the PAN 0256, the issuer server computer 150 may generate a first payment token 7891 (along with an expiration date and any other suitable information) to represent the PAN 0256 (e.g. using the payment token generation module 555 and the payment token association module 556). The issuer server computer 150 may also store a record in the payment token database 553 including the PAN 0256 and the associated first payment token 7891.

The first payment token 7891 may be a channel-specific payment token that is generated specifically for the communication device 120. Also, the first payment token 7891 may be one of a plurality of first payment tokens associated with the PAN 0256. For example, referring back to FIG. 6, the first payment token 9471 associated with Bob's device 2 may also be associated with the PAN 0256 at the issuer server computer 150.

In step S740, the payment processor server computer 140 may receive a provisioning response message from the issuer server computer 150. The provisioning response message may include the PAN 0256, the associated first payment token 7891, and any other suitable information.

In step S745, the payment processor server computer 140 may generate a second payment token 4969 associated with the first payment token 7891 (e.g. using the payment token generation module 445 and the payment token association module 446).

In step S750, the payment processor server computer 140 may store a record in the payment token database 443 including the second payment token 4969, the first payment token 7891, and the PAN 0256.

In step S755, the payment processor server computer 140 may provide the second payment token 4969 and any other suitable information to the communication device 120 (e.g. using the provisioning module 447). For example, the payment processor server computer 140 may generate and deliver provisioning scripts to the communication device 120 (e.g. directly or via the digital wallet provider server computer 130). In some embodiments, the last four digits of the PAN 0256 and/or the last four digits of the first payment token 7891 may also be provided to the communication device 120.

The communication device 120 may then be able to use the second payment token 4969 for payments. A mobile application on the communication device 120 may display a virtual payment device that represents the provisioned second payment token 4969. In some embodiments, the virtual payment device may include the last four digits of the second payment token 4969, first payment token 7891, or the PAN 0256.

In step S760, the payment processor server computer 140 may notify the issuer server computer 150 that the second payment token 4969 is associated with the first payment token 7891. The issuer server computer 150 may update the record in the payment token database 553 to include the second payment token 4969.

Accordingly, if the communication device 110 and/or second payment token 4969 are compromised, the issuer server computer 150 can identify, replace, and/or inactivate the associated first payment token 7891 rather than re-issuing a new PAN and payment device (which would affect other devices and payment tokens associated with the PAN 0256). Moreover, the first payment token 7891 allows the issuer server computer 150 to lock the specific payment channel, instead of locking the PAN 0256 for all payment channels.

In some embodiments, if a replacement first payment token is provided by the issuer server computer 150, the payment processor server computer 140 can generate a replacement second payment token, update the payment token database 443 with the new payment tokens, provide the replacement second payment token to the communication device 110, and notify the issuer server computer 150 about the replacement second payment token.

Referring back to step S735, in some embodiments, the issuer server computer 150 may not respond to the provisioning request message within a predetermined amount of time. Regarding this scenario, a method 800 according to embodiments of the invention can be described with respect to FIG. 8.

Similar to the method 700, in the method 800, a process can be initiated for provisioning the PAN 0256 to the communication device 120. Also, similar to steps S710 through S735, several messages can be sent (e.g. tokenization eligibility request message, tokenization eligibility response message, and provisioning request message) in steps S810 through S835. However, the payment processor server computer 140 may not receive a provisioning response message within a predetermined period of time (e.g. 5 seconds, 10 seconds, 30 seconds, 1 minute, 5 minutes, or any other suitable amount of time). Accordingly, in order to reduce the delay, the payment processor server computer 140 may proceed with the provisioning process without having received authorization or the first payment token 7891 from the issuer server computer 150.

In step S840, the payment processor server computer 140 may initiate STIP (stand-in processing), generate the second payment token 4969, and associate the second payment token 4969 with the PAN 0256 (e.g. using the STIP module 448, the payment token generation module 445, and the payment token association module 446).

In step S845, the payment processor server computer 140 may store a record in the payment token database 443 including the PAN 0256 and the associated second payment token 4969. In this embodiment, the second payment token may be generated and stored before the first payment token is generated and stored.

In step S850, the payment processor server computer 140 may provide the second payment token 4969, the last four digits of the PAN 0256, and any other suitable information to the communication device 120 (e.g. using the provisioning module). For example, the payment processor server computer 140 may generate and deliver provisioning scripts to the communication device 120 (e.g. directly or via the digital wallet provider server computer 130).

In step S855, the payment processor server computer 140 may notify the issuer server computer 150 that STIP has taken place and that the second payment token 4969 is associated with the PAN 0256.

The issuer server computer 150 may then determine whether or not to authorize provisioning based on the PAN 0256, the communication device 120, and/or any other suitable information. In some embodiments, the issuer server computer 150 may generate the first payment token 7891 (along with an expiration date and any other suitable information) to represent the PAN 0256. The issuer server computer 150 may also store a record in the payment token database 553 including the PAN 0256, the associated first payment token 7891, and the associated second payment 4969.

In step S860, the payment processor server computer 140 may receive a token maintenance message (in some embodiments referred to as a token response message) from the issuer server computer 150. The token maintenance message may include the PAN 0256, the associated second payment token 4969, and the associated first payment token 7891. The token maintenance message may indicate that the first payment token 7891 should be used instead of the PAN 0256.

In step S865, the payment processor server computer 140 may update the record in the payment token database 543 to include the first payment token 7891. The record may indicate that, for any future authorization request messages, the second payment token 4969 should be replaced with the associated first payment token 7891 (and not the associated PAN 0256).

In step S870, the payment processor server computer 140 may notify the issuer server computer 150 that the first payment token 7891 has been stored and linked with the second payment token 4969 and the PAN 0256 at the payment processor server computer 140.

Accordingly, the second payment token 4969 may be linked with the first payment token 7891 before provisioning (as described with respect to FIG. 7), or payment tokenization may be completed after the second payment token 4969 has already been provisioned into the communication device 120 (as described with respect to FIG. 8).

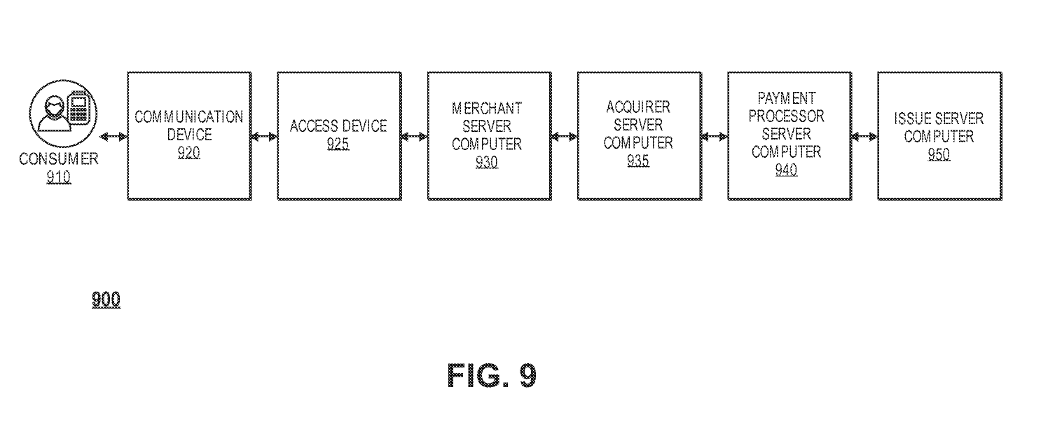

FIG. 9 shows a system used to conduct a payment transaction according to an embodiment of the invention. The system comprises a consumer 910 who may operate a communication device 920. The consumer 910 may use communication device 920 to conduct purchase transactions at an access device 925 connected to a merchant server computer 930. Merchant server computer 930 may be connected to acquirer server computer 935. Acquirer server computer 935 may be connected to issuer computer 950 via payment processor server computer 940.

In a typical purchase transaction, the consumer 910 purchases a good or service at the merchant using a communication device 920 (e.g., a mobile phone). The consumer's communication device 920 can interact with an access device 925 at a merchant associated with merchant server computer 930. For example, the consumer 910 may tap the communication device 920 against an NFC reader in the access device 925. Alternatively, the consumer 910 may indicate payment details to the merchant electronically, such using a digital wallet or in an online transaction.

An authorization request message is generated by the access device 925 and is then forwarded to the acquirer server computer 935. Typically, the authorization request message will include a field for a primary account number (PAN) associated with the communication device 920. After receiving the authorization request message, the authorization request message is then sent to the payment processor server computer 940. The payment processor server computer 940 then forwards the authorization request message to the corresponding issuer server computer 950 associated with the issuer of the consumer's account. The PAN included in the authorization request message may be used to route the message to the appropriate issuer computer 950.

After the issuer server computer 950 receives the authorization request message, the issuer server computer 950 sends an authorization response message back to the payment processor server computer 940 to indicate whether or not the current transaction is authorized (or not authorized). The payment processor server computer 940 then forwards the authorization response message back to the acquirer server computer 935. The acquirer server computer 935 then sends the response message back to the merchant server computer 930. In some embodiments, such as when a fraud rule is triggered at payment processor server computer 940, payment processor server computer 940 may decline a transaction previously authorized by the issuer server computer 950.

After the merchant server computer 930 receives the authorization response message, the access device at the merchant server computer 930 may then provide the authorization response message for the consumer 910. The response message may be displayed by the contactless access device, or may be printed out on a receipt. Alternately, if the transaction is an online transaction, the merchant may provide a web page or other indication of the authorization response message.

At the end of the day, a normal clearing and settlement process can be conducted by the payment processor server computer 940. A clearing process is a process of exchanging financial details between and acquirer and an issuer to facilitate posting to a consumer's payment account and reconciliation of the consumer's settlement position. However, it should be noted that embodiments of the invention are not limited to a single settlement process.

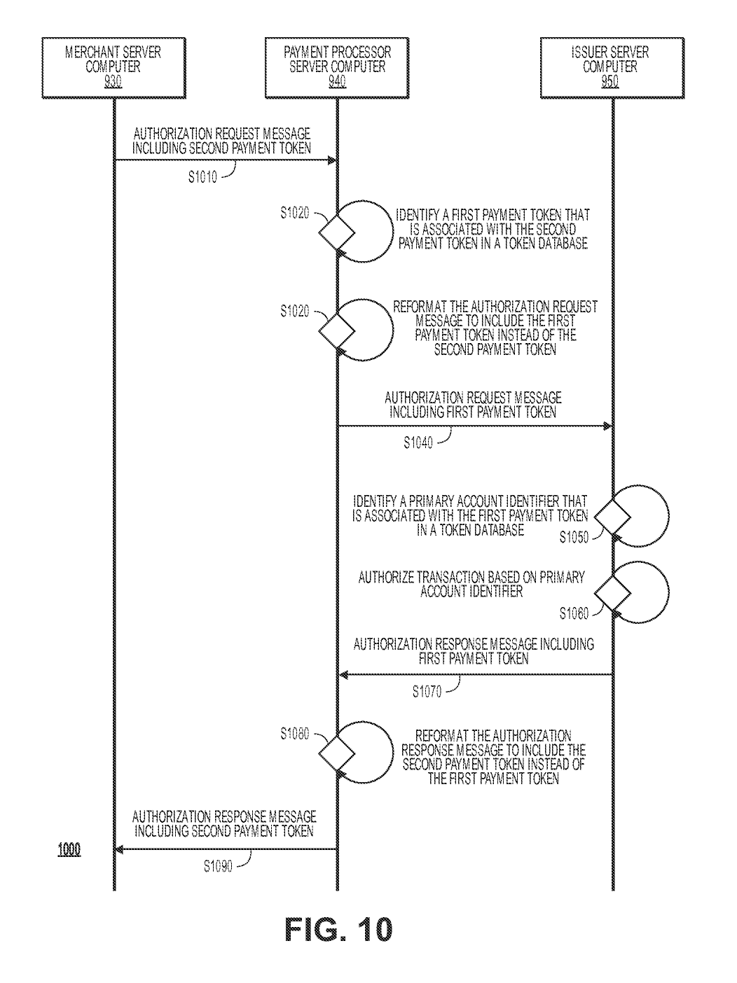

A method 1000 according to embodiments of the invention can be described with respect to FIG. 10. The method 1000 demonstrates an example transaction that involves the above described tokenization system.

The consumer 910 may attempt to purchase a good or service from a merchant. For example, the consumer 910 may provide payment credentials to the access device 925 via the communication device 920. The communication device 920 may provide the second payment token 4969 to the access device 925 via NFC, QR, or any other suitable means of communication.

In step S1010, the payment processor server computer 940 may receive an authorization request message including the second payment token 4969 for a transaction from the merchant server computer 930 (e.g. using the acquirer server computer 935).

In step S1020, the payment processor server computer 940 may de-tokenize the second payment token 4969 by identifying the first payment token 7891 that is associated with the second payment token 4969 in the payment token database 443. As discussed above, the payment processor server computer 940 may have previously generated the second payment token 4969, and the issuer server computer 950 may have previously generated the first payment token 7891.

In step S1030, the payment processor server computer 940 may reformat the authorization request message to include the first payment token 7891 instead of the second payment token 4969 (e.g. using the communication module 449). In step S1040, the payment processor server computer 940 may send the authorization request message to the issuer server computer 950.

In step S1050, the issuer server computer 950 may de-tokenize the first payment token 7891 by identifying the PAN 0256 associated with the first payment token 7891 in the payment token database 553.

In step S1060, the issuer server computer 950 may then authorize the transaction based on the PAN 0256, transaction details, and any other suitable information (e.g. using the authorization module 558).

In step S1070, the payment processor server computer 940 may receive an authorization response message including the first payment token 7891 from the issuer server computer 950.

In step S1080, the payment processor server computer 940 may reformat the authorization response message to include the second payment token 4969 instead of the first payment token 7891.

In step S1090, the payment processor server computer 940 may send the authorization response message to the merchant server computer 930 (e.g. via the acquirer server computer 935). The merchant may then release the goods or services to the consumer 910 based on the authorization response message.

At the end of the day, a normal clearing and settlement process can be conducted by the payment processor server computer 940. A clearing process is a process of exchanging financial details between and acquirer and an issuer to facilitate posting to a consumer's payment account and reconciliation of the consumer's settlement position. However, it should be noted that embodiments of the invention are not limited to a single settlement process.

Embodiments of the invention have a number of advantages. At least two levels of tokenization enhance the security of provisioned payment credentials, as the first payment token may be kept secret. The first payment token may be under the control of the issuer and may be only distributed to a central payment processor computer. If a second payment token related to the first payment token is compromised, the issuer may deactivate the first payment token immediately thereby preventing future potential fraudulent transaction using the compromised first payment token. The issuer does not need to contact the central payment processor computer, thereby saving time and reducing the risk of fraudulent transactions being conducted. Also, since many channel-specific second payment tokens can be generated from multiple first payment tokens, the compromise of one first and second payment token pair will not render other first and second payment token pairs ineffective.

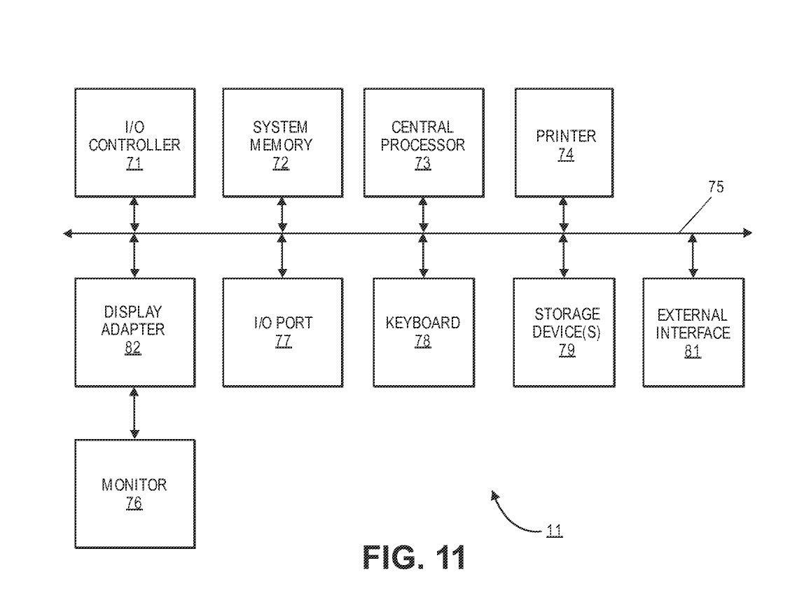

FIG. 11 is a high-level block diagram 11 of a computer system that may be used to implement any of the entities or components described above. The subsystems shown in FIG. 11 are interconnected via a system bus 75. Additional subsystems include a printer 74, keyboard 78, storage device 79, and monitor 76, which is coupled to display adapter 82. Peripherals and input/output (I/O) devices, which couple to I/O controller 71, can be connected to the computer system by any number of means known in the art, such as a serial port. For example, I/O port 77 or external interface 81 can be used to connect the computer apparatus to a wide area network such as the Internet, a mouse input device, or a scanner. The interconnection via system bus 75 allows the central processor 73 to communicate with each subsystem and to control the execution of instructions from system memory 72 or the storage device 79, as well as the exchange of information between subsystems. The system memory 72 and/or the storage device may embody a computer-readable medium.

Although a specific sequence of steps are described, and shown in the Figures, specification, and claims, it is understood that, unless specified to the contrary, embodiments of the invention may include such steps in any suitable order without departing from the spirit and scope of the invention.

As described, the inventive service may involve implementing one or more functions, processes, operations or method steps. In some embodiments, the functions, processes, operations or method steps may be implemented as a result of the execution of a set of instructions or software code by a suitably-programmed computing device, microprocessor, data processor, or the like. The set of instructions or software code may be stored in a memory or other form of data storage element which is accessed by the computing device, microprocessor, etc. In other embodiments, the functions, processes, operations or method steps may be implemented by firmware or a dedicated processor, integrated circuit, etc.

Any of the software components or functions described in this application may be implemented as software code to be executed by a processor using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may reside on or within a single computational apparatus, and may be present on or within different computational apparatuses within a system or network.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

As used herein, the use of “a”, “an” or “the” is intended to mean “at least one”, unless specifically indicated to the contrary.

What is claimed is:

1. A method comprising:
receiving, by a payment processor server computer, a provisioning request associated with a communication device, the provisioning request including a primary account identifier of an account associated with an issuer;
sending, by the payment processor server computer, the provisioning request to an issuer server computer;
receiving, by the payment processor server computer, a provisioning response from the issuer server computer, the provisioning response including a first payment token associated with the primary account identifier and generated by the issuer server computer, the first payment token being one of a plurality of first payment tokens associated with the primary account identifier;
generating, by the payment processor server computer, a second payment token associated with the first payment token;
storing, by the payment processor server computer, the first payment token and the second payment token in a payment token database;
providing, by the payment processor server computer, the second payment token to the communication device; and
notifying, by the payment processor server computer, the issuer server computer that the second payment token is associated with the first payment token.

2. The method of claim 1, wherein the issuer server computer is informed that the second payment token is compromised, and wherein the issuer server computer cancels the first payment token so that the second payment token is no longer valid.

3. The method of claim 2, wherein the primary account identifier and other first payment tokens associated with the primary account identifier remain active.

4. The method of claim 2, further comprising:
receiving, by the payment processor server computer, a replacement first payment token associated with the primary account identifier from the issuer server computer;
generating, by the payment processor server computer, a replacement second payment token associated with the replacement first payment token;
storing, by the payment processor server computer, the replacement first payment token and the replacement second payment token in the payment token database;
providing, by the payment processor server computer, the replacement second payment token to the communication device; and
notifying, by the payment processor server computer, the issuer server computer that the replacement second payment token is associated with the replacement first payment token.

5. The method of claim 1, wherein the provisioning response is not received from the issuer server computer within a predetermined amount of time, wherein the second payment token is generated and provided to the communication device after the predetermined amount of time and before receiving the provisioning response with the first payment token, and wherein the method further comprises:
notifying, by the server computer, the issuer server computer that the second payment token has been provided to the communication device before receiving the provisioning response.

6. A payment processor server computer comprising:
a processor; and
a non-transitory computer readable medium coupled to the processor, the non-transitory computer readable medium comprising a payment token database and code executable by the processor for implementing a method comprising:
receiving a provisioning request associated with a communication device, the provisioning request including a primary account identifier of an account associated with an issuer;
sending the provisioning request to an issuer server computer;
receiving a provisioning response from the issuer server computer, the provisioning response including a first payment token associated with the primary account identifier and generated by the issuer server computer, the first payment token being one of a plurality of first payment tokens associated with the primary account identifier;
generating a second payment token associated with the first payment token;
storing the first payment token and the second payment token in the payment token database;
providing the second payment token to the communication device; and
notifying the issuer server computer that the second payment token is associated with the first payment token.

7. The payment processor server computer of claim 6, wherein the communication device is capable of being used to conduct a payment transaction.

8. The payment processor server computer of claim 6, wherein the second payment token is a 16-digit number that is formatted as a primary account identifier.

9. The payment processor server computer of claim 6, wherein the first payment token is a channel-specific payment token.

10. The payment processor server computer of claim 6, wherein each first payment token from the plurality of first payment tokens is associated with a different communication device.

11. A method comprising:
receiving, by a payment processor server computer, an authorization request message comprising a second payment token for a transaction from a merchant server computer;
identifying, by the payment processor server computer, a first payment token that is associated with the second payment token in a payment token database, wherein the second payment token was previously generated by the payment processor server computer, and wherein the first payment token was previously generated by an issuer server computer;
reformatting, by the payment processor server computer, the authorization request message to include the first payment token instead of the second payment token;
transmitting, by the payment processor server computer, the authorization request message to the issuer server computer, wherein the issuer server computer authorizes the transaction based on a primary account identifier associated with the first payment token at the issuer server computer;
receiving, by the payment processor server computer, an authorization response message comprising the first payment token from the issuer server computer;
reformatting, by the payment processor server computer, the authorization response message to include the second payment token instead of the first payment token; and
transmitting, by the payment processor server computer, the authorization response message to the merchant server computer.

12. The method of claim 11, wherein the second payment token is provided to the merchant server computer for the transaction by a communication device.

13. The method of claim 11, wherein the first payment token is one of a plurality of first payment tokens associated with the primary account identifier at the issuer server computer.

14. The method of claim 13, wherein the first payment token can be replaced or canceled without affecting the primary account identifier or other first payment tokens associated with the primary account identifier.

15. The method of claim 11, wherein the payment processor server is in a payment processing network.

16. A payment processor server computer comprising:
a processor; and
a non-transitory computer readable medium coupled to the processor, the non-transitory computer readable medium comprising a payment token database and code executable by the processor for implementing a method comprising:
receiving an authorization request message comprising a second payment token for a transaction from a merchant server computer;
identifying a first payment token that is associated with the second payment token in a payment token database, wherein the second payment token was previously generated by the payment processor server computer, and wherein the first payment token was previously generated by an issuer server computer;
reformatting the authorization request message to include the first payment token instead of the second payment token;
transmitting the authorization request message to the issuer server computer, wherein the issuer server computer authorizes the transaction based on a primary account identifier associated with the first payment token at the issuer server computer;
receiving an authorization response message comprising the first payment token from the issuer server computer;
reformatting the authorization response message to comprise the second payment token instead of the first payment token; and
transmitting the authorization response message to the merchant server computer.

17. The server computer of claim 16, wherein the first payment token is associated with a communication device.

18. The server computer of claim 16, wherein the first payment token is one of a plurality of first payment tokens associated with the primary account identifier at the issuer server computer, and wherein each first payment token is associated with a different communication device.

19. The server computer of claim 18, wherein the first payment token can be replaced or canceled without affecting the primary account identifier or other first payment tokens associated with the primary account identifier.

20. The server computer of claim 16, wherein the first payment token and the second payment token have the same format and the same number of digits.
